(19) United States
(12) Patent Application Publication
(10) Pub. No.: US 2003/0202487 A1
(43) Pub. Date: Oct. 30, 2003

(54) Method and apparatus for reducing call setup time

(76) Inventors: John M. Harris, Chicago, IL (US); Ronald T. Crocker, St. Charles, IL (US); Valentin Oprescu-Surcobe, Northbrook, IL (US)

Correspondence Address: MOTOROLA, INC., 1303 EAST ALGONQUIN ROAD, IL01/3RD, SCHAUMBURG, IL, 60196

(21) Appl. No.: 10/413,230

(22) Filed: Apr. 14, 2003

Related U.S. Application Data
(60) Provisional application No. 60/375,773, filed on Apr. 26, 2002.

(51) Int. Cl. H04Q 7/00

(52) U.S. Cl. 370/329

(57) ABSTRACT

To address the need for reducing call setup time without degrading the originator's service, a RAN (103) transmits a channel assignment message in a paging slot monitored by a target unit (113). The target unit responds to this channel assignment page indicating its availability and location within the RAN coverage area. The RAN then indicates the availability of the target unit to the calling unit (120) that originated the service request. In this way, the originator is able to proceed with the communication service, while the target completes its call setup.

### REFERENCE(S) TO RELATED APPLICATION(S)

The present application claims priority from provisional application, Serial No. 60/375773, entitled “METHOD AND APPARATUS FOR REDUCING CALL SETUP TIME,” filed Apr. 26, 2002, which is commonly owned and incorporated herein by reference in its entirety.

This application is related to a co-pending application entitled “METHOD AND APPARATUS FOR EFFICIENT CHANNEL ASSIGNMENT,” filed on even date herewith, and assigned to the assignee of the instant application.

This application is related to a co-pending application, Ser. No. 10/303255, entitled “METHOD FOR EXPEDITING TRANSITIONS BETWEEN STATES OF OPERATION IN COMMUNICATIONS EQUIPMENT,” filed on Nov. 25, 2002, and assigned to the assignee of the instant application.

This application is related to a co-pending application, Ser. No. 09/887172, entitled “DISPATCH CALL ORIGINATION AND SET UP IN A CDMA MOBILE COMMUNICATION SYSTEM,” filed on Jun. 22, 2001, and assigned to the assignee of the instant application.

This application is related to a co-pending application, Ser. No. 10/108405, entitled “METHOD AND APPARATUS FOR WIRELESS DATA TRANSFER WITH REDUCED DELAY,” filed on Mar. 28, 2002, and assigned to the assignee of the instant application.

This application is related to a co-pending application, Ser. No. 10/108783, entitled “METHOD AND APPARATUS TO REDUCE WIRELESS DATA TRANSFER DELAY,” filed on Mar. 28, 2002, and assigned to the assignee of the instant application.

### FIELD OF THE INVENTION

The present invention relates generally to communication systems and, in particular, to reducing call setup time in communication systems.

### BACKGROUND OF THE INVENTION

Dispatch communication services are not yet provided on CDMA-based communication systems. Unlike the interconnect services provided by today's cellular systems, dispatch services have been traditionally provided by two-way radio systems. Such services allow a user to communicate in ways that are difficult or costly using today's cellular systems. The dispatch group call service, for example, enables a user to communicate with a group of people simultaneously and instantaneously, usually just by depressing a push-to-talk (PTT) button. Using a cellular system, such a call could not occur instantaneously since either telephone numbers would need to be dialed for a three-way call or arrangements would need to be made to setup a conference call.

Likewise, the dispatch individual (typically called a private call) call service enables a user to communicate with another user quickly and spontaneously. This feature is ideal for two people who are working together but are unable to speak with one another directly such as two people working in concert but in different parts of a building. Where a wireless telephone call is more appropriate for a conversation, short messages between two people as they work are better facilitated by the dispatch individual call service.

Because of the instantaneous nature of dispatch communication, low delay is a critical factor for dispatch calls. For example, delay that is acceptable for a typical interconnect voice call, can be unacceptable for dispatch services which rely on a very fast connection being made to the called party. Therefore, the time it takes to setup a dispatch call is critical. Low delay (or latency) is also critical when establishing and re-establishing data sessions.

FIG. 1A illustrates a prior art messaging time-line for setting up a dispatch call between an originating mobile unit and a target mobile unit. After the originator's PTT, the radio access network pages the target unit, receives a page response, transmits a channel assignment message, and then finally signals the originating mobile that the call may begin. The originating unit will generate a talk permit tone (TPT) signaling the user that he or she may begin speaking. From the user's perspective the call has finally begun. Meanwhile, the target mobile proceeds with traffic channel (TCH) setup, generates a tone when complete to get the user's attention and then begins playing the audio received via the TCH.

One proposal to shorten this call setup procedure is to page with a channel assignment message. Thus, as illustrated in FIG. 1B, upon receiving the channel assignment message, the target mobile jumps to the assigned traffic channel. This approach has the benefit of reducing the time from when a page/channel assignment is sent to the mobile until the mobile is on the traffic channel. The result is that the target may generate its tone and be ready to play the audio sooner (e.g., 100 milliseconds sooner). However, a side-effect is the longer delay experienced by the originating user. The delay from PTT to TPT can increase by approximately 400 milliseconds. Thus, the originator, the one most aware of the entire call setup delay, may wait significantly longer to start speaking. Therefore, a need exists for a method and apparatus to reduce call setup time without degrading the originator's service.

### BRIEF DESCRIPTION OF THE DRAWINGS

FIG. 1A illustrates a prior art messaging time-line for setting up a dispatch call between an originating mobile unit and a target mobile unit.

FIG. 1B illustrates a prior art messaging time-line for setting up a dispatch call between an originating mobile unit and a target mobile unit.

FIG. 1C illustrates a messaging time-line for setting up a dispatch call between an originating mobile unit and a target mobile unit in accordance with a preferred embodiment of the present invention.

FIG. 2 is a block diagram depiction of a communication system in accordance with a first embodiment of the present invention.

FIG. 3 is a logic flow diagram of steps executed by a radio access network (RAN) in accordance with a first embodiment of the present invention.

FIG. 4 is a logic flow diagram of steps executed by a remote unit in accordance with a first embodiment of the present invention.

### DETAILED DESCRIPTION OF EMBODIMENTS

To address the need for reducing call setup time without degrading the originator's service, a RAN transmits a channel assignment message in a paging slot monitored by a target unit. The target unit responds to this channel assignment page indicating its availability and location within the RAN coverage area. The RAN then indicates the availability of the target unit to the calling unit that originated the service request. In this way, the originator is able to proceed with the communication service, while the target completes its call setup.

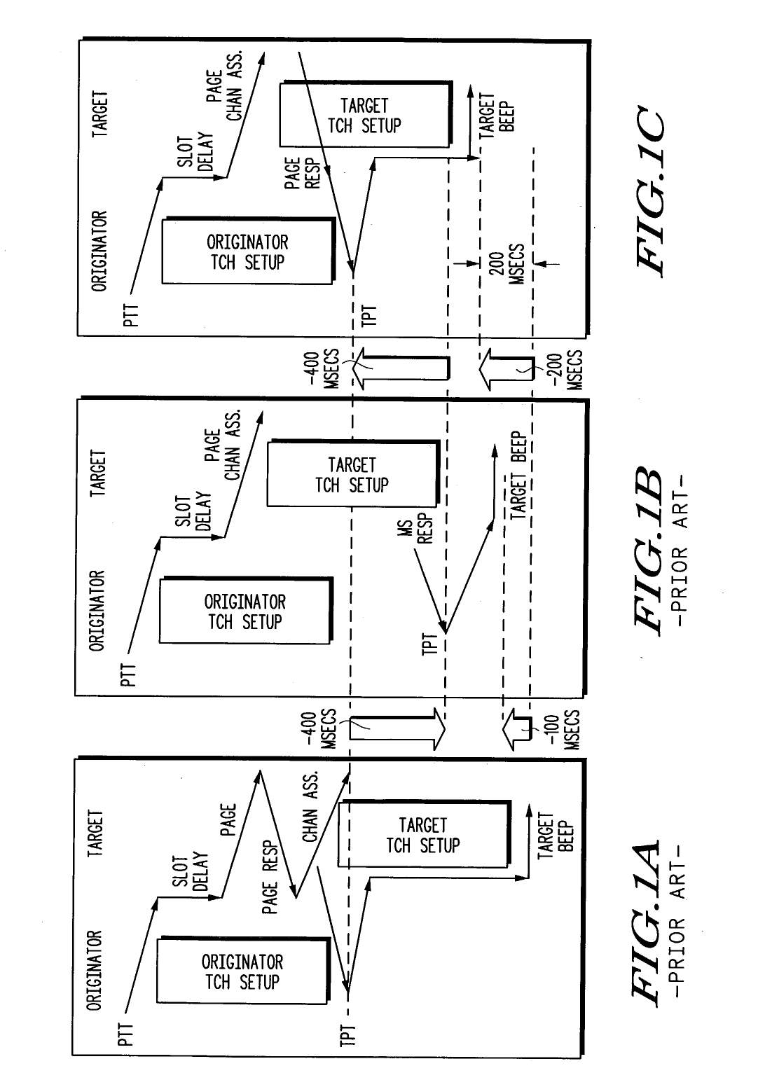

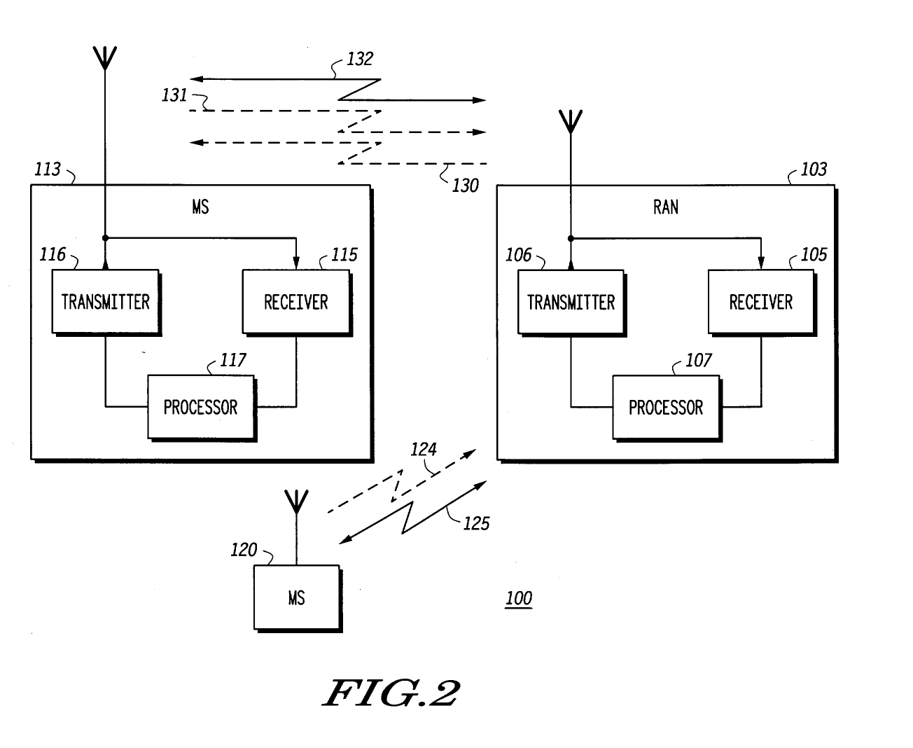

The present invention can be more fully understood with reference to FIGS. 1C, 2, and 3. FIG. 2 is a block diagram depiction of a communication system 100 in accordance with a first embodiment of the present invention. Communication system 100 is a well-known Code Division Multiple Access (CDMA) system, specifically a CDMA 2000 system, which is based on the Telecommunications Industry Association/Electronic Industries Association (TIA/EIA) standard IS-2000, suitably modified to implement the present invention. Alternative embodiments of the present invention may be implemented in communication systems that employ other technologies such as WCDMA, UMTS, GSM, GPRS, and EDGE.

The first embodiment of the present invention includes radio access network (RAN) 103 and remote units, such as mobile stations (MSs) 113 and 120. However, the present invention is not limited to remote units that are mobile. For example, a remote unit may comprise a desktop computer wirelessly connected to the radio access network. In general, throughout this document the terms “base station” (BS) and Radio Access Network (“RAN”) can be seen as synonymous. Similarly, the terms “mobile station,” “user equipment,” “mobile terminal,” “mobile unit” and “remote unit” can be seen, in general, as synonymous.

Those skilled in the art will recognize that FIG. 2 does not depict all of the network equipment necessary for system 100 to operate but only those system blocks particularly relevant to the description of embodiments of the present invention. For example, RAN 103 comprises well-known entities such as a transmitter 106, receiver 105, and controller 107. Those skilled in the art are aware of the many ways each of these entities can be implemented and/or purchased from wireless communications companies such as “MOTOROLA.” Controllers, for example, typically comprise components such as processors, memory, and/or logic circuitry designed to implement algorithms that have been expressed as computer instructions and/or in circuitry. Given an algorithm or a logic flow, those skilled in the art are aware of the many design and development techniques available to implement a controller to perform the logic.

Typically, RAN transmitters and receivers are components of RAN base transceiver stations (BTSs), which interface with devices such as base site controllers, mobile switching centers/visitor location registers (MSC/VLR), home location registers (HLR), etc. In a first embodiment of the present invention, a known CDMA 2000 RAN is adapted using known telecommunications design and development techniques to implement the RAN aspect of the present invention. The result is RAN 103, which performs the method described with respect to FIG. 3. Those skilled in the art will recognize that the RAN aspect of the present invention may be implemented in and across various physical components of RAN 103.

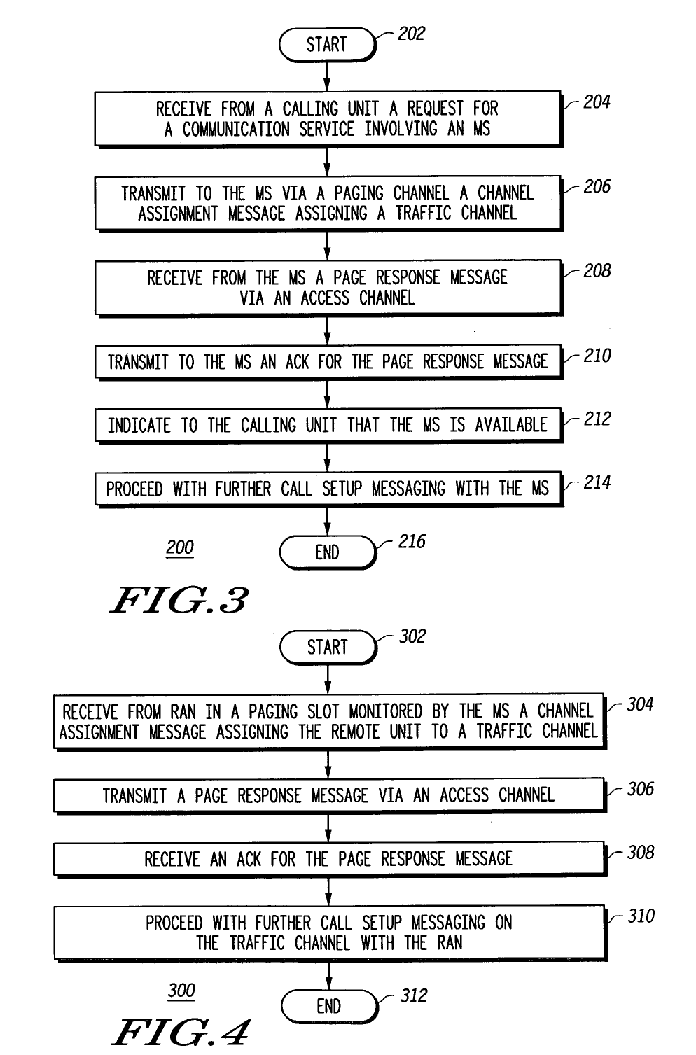

MS 113 comprises receiver 115, transmitter 116, and processor 117 (comprising e.g., memory and processing devices). Transmitters, receivers, and processors as used in CDMA MSs are all well known in the art. This common set of MS components is adapted using known telecommunications design and development techniques to implement the remote unit aspect of the present invention. Thus modified, MS 113 performs the method described with respect to FIG. 4.

RAN 103 and MSs 113 and 120 communicate via CDMA 2000 air interface resources 124-125 and 130-132. Resource 130 comprises a paging channel, resources 124 and 131 comprise access channels, and resources 125 and 132 comprises traffic channels (TCHs) that are assigned when MSs 113 and 120 are active in calls.

Operation of communication system 100 in accordance with an embodiment of the present invention occurs substantially as follows. As the calling unit, MS 120 transmits a service request to RAN 103 via access channel 124. As depicted in FIG. 2, RAN 103 is shown to have a single transmitter and receiver. However, as is well known, a RAN may encompass many base sites covering a wide geographic area. Thus, MSs 113 and 120 may be anywhere within RAN 103 and are certainly not limited to the same base site or location area. In fact, the calling unit may instead be a public switched telephone network (PSTN) user rather than a mobile user.

Upon receiving the service request (e.g., a dispatch service request or a packet data (re)connection request) from calling unit 120, RAN 103 begins TCH setup (see also FIG. 1C) with MS 120 using available TCH 125. RAN 103 also needs to locate and determine the availability of target MS 113. This would normally be done by paging MS 113. However, to reduce call setup time RAN 103 assembles a channel assignment message rather than page message and pages the MS 113 by transmitting the channel assignment message rather than a page message. In effect, RAN 103 pages MS 113 with this channel assignment message by transmitting it from base sites in MS 113's location area, in paging slots that MS 113 would regularly monitor for pages.

The channel assignment message sent via paging channel 130 is a modified channel assignment message assembled using configuration information from a previous wireless service session (e.g. a service option or a RF characteristic such as the FRAME_OFFSET). The message includes an identification of the assigned traffic channel and the type of communication service that is requested. Additionally, it includes the manner in which the receiving MS should respond. For example, the receiving MS may be instructed to transmit a response and wait for an acknowledgement. Thus, the MS would transmit a response and proceed to the assigned traffic channel only after receiving an acknowledgement from the RAN to its transmitted response. Instead, the receiving MS may be instructed to transmit a response without waiting for any acknowledgement. Thus, the MS would transmit a response and proceed to the assigned traffic channel without waiting for any acknowledgement (although it may still monitor for an acknowledgement as it continues on the traffic channel). Instead, the receiving MS may be instructed to proceed to the channel assigned in the channel assignment message before transmitting any response. In this case, the MS would proceed to the channel assigned in the channel assignment message without transmitting any response. Also, the contents of one type of a modified channel assignment message are described in the cross-referenced, co-pending application entitled “METHOD AND APPARATUS FOR EFFICIENT CHANNEL ASSIGNMENT,” which is hereby incorporated by reference.

In addition to transmitting the channel assignment message, RAN 103 assigns and begins transmission on available TCH 132. Upon receiving the channel assignment message, MS 113 transmits a response to the RAN, if instructed to do so. In the present embodiment, this response comprises a modified page response message transmitted via access channel 131. In fact, this modified page response message may be transmitted in duplicate to increase its likelihood of receipt.

The response indicates the availability and the capability, or lack thereof, of the mobile unit to proceed with the said service as well as indicating the mobile unit location relative to the RAN. The act of transmitting indicates to the RAN that MS 113 is available (i.e., not powered down or outside of RAN 103's coverage area) and indicates MS 113's RAN location (i.e., its serving site). A positive response also indicates that MS 113 is capable of providing the service, while a negative response indicates that the mobile unit will not acquire the assigned traffic channel and will not proceed with the service for some reason.

Thus, RAN 103 receives the page response message via access channel 131. For RAN 103's benefit, the message also indicates that a channel assignment message is being responded to rather than a page. In the present embodiment, RAN 103 may or may not acknowledge the page response message received depending on how the mobile was instructed in the channel assignment message.

Having received a response from MS 113, RAN 103 can now indicate to MS 120 that the target unit is available. This indication may comprise transmitting a Complete Layer 3 Information: Paging Request or a CM_Service_Request message to MS 120, for example. Thus, upon receiving this indication, MS 120 may proceed either with beginning the service or completing any remaining call setup. In the case of a dispatch service request, MS 120 will generate a talk permit tone (TPT) signaling the user that he or she may begin speaking. Or in the case of a data service, MS 120 may begin sending data or content. Thus, the service originator is able to begin the service as soon as the target unit responds to the channel assignment page and the RAN indicates the target unit's availability. Meanwhile, RAN 103 and MS 113 proceed with further call setup messaging in parallel.

FIG. 3 is a logic flow diagram of steps executed by a radio access network (RAN) in accordance with a first embodiment of the present invention. Logic flow 200 begins (202) when the RAN receives (204) a request from a calling unit for a communication service involving another remote unit. The RAN transmits (206) a channel assignment message that assigns a traffic channel for the service to the remote unit via a paging channel. In response, the RAN receives (208) from the remote unit a page response message.

The RAN may then transmit (210) an acknowledgement to the remote unit for the page response message. Whether or not an ACK is transmitted, upon receiving the page response message, the RAN indicates (212) to the calling unit that the remote unit is available (i.e., that the call may proceed). The RAN also proceeds (214) with any further call setup messaging with the remote unit, and the logic flow ends (216). Note that although steps 210 and 212 are shown to intervene between the receiving of the page response message and further call setup, their performance does not delay the continuous call setup messaging that occurs between the RAN and the remote unit. In effect, steps 210, 212, and 214, can be viewed as occurring in parallel.

FIG. 4 is a logic flow diagram of steps executed by a remote unit in accordance with a first embodiment of the present invention. Logic flow 300 begins (302) when the remote unit receives (304) a channel assignment message in a paging slot it monitors for pages. The remote unit then transmits (306) a page response message via an access channel and proceeds (310) to the assigned traffic channel for further call setup messaging. The remote unit may also receive (308) an acknowledgement from the RAN of its page response transmission; however, as indicated above, steps 308 and 310 can be viewed as occurring in parallel.

While the present invention has been particularly shown and described with reference to particular embodiments thereof, it will be understood by those skilled in the art that various changes in form and details may be made therein without departing from the spirit and scope of the present invention.

What is claimed is:

1. A method for a radio access network (RAN) to reduce call setup time comprising:
receiving a request from a calling unit for a communication service involving a remote unit;
transmitting to the remote unit via a paging channel a channel assignment message that assigns the remote unit to a traffic channel;
receiving from the remote unit a response to the channel assignment message, wherein the response indicates an availability of the remote unit and a remote unit RAN location;
indicating to the calling unit that the remote unit is available; and
proceeding with further call setup messaging with the remote unit.

2. The method of claim 1, wherein transmitting the channel assignment message comprises:
assembling the channel assignment message rather than assembling a page message for the remote unit; and
paging the remote unit by transmitting in a monitored paging slot of the remote unit the channel assignment message rather than a page message.

3. The method of claim 1, wherein the response to the channel assignment message comprises a page response message received via an access channel.

4. The method of claim 3, wherein the page response message indicates that a channel assignment message is being responded to rather than a page.

5. The method of claim 1, wherein indicating to the calling unit that the remote unit is available comprises transmitting a Complete Layer 3 Information: Paging Request message to the calling unit.

6. The method of claim 1, wherein the channel assignment message indicates a manner of responding selected from the group consisting of transmitting a response without waiting for any acknowledgement, transmitting a response and waiting for an acknowledgement, and proceeding to the channel assigned in the channel assignment message before transmitting any response.

7. The method of claim 1, wherein the channel assignment message indicates the communication service.

8. The method of claim 1, further comprising transmitting an acknowledgement to the remote unit in response to receiving from the remote unit the response to the channel assignment message.

9. The method of claim 1, wherein the channel assignment message is assembled using configuration information from a previous wireless service session.

10. The method of claim 1, wherein the response to the channel assignment message comprises a response message received via an access channel.

11. A method for a remote unit to reduce call setup time comprising:
receiving from a radio access network (RAN) via a paging channel a channel assignment message that assigns the remote unit to a traffic channel;
transmitting to the RAN a response to the channel assignment message, wherein the response indicates an availability of the remote unit and a remote unit RAN location; and
proceeding with further call setup messaging on the traffic channel with the RAN.

12. The method of claim 11, wherein the response to the channel assignment message comprises a response message transmitted via an access channel.

13. The method of claim 11, wherein the channel assignment message is received in a paging slot monitored by the remote unit.

14. The method of claim 11, wherein the response to the channel assignment message comprises a page response message transmitted via an access channel.

15. The method of claim 14, wherein the page response message indicates that a channel assignment message is being responded to.

16. The method of claim 11, wherein the channel assignment message indicates a manner of responding selected from the group consisting of transmitting a response without waiting for any acknowledgement, transmitting a response and waiting for an acknowledgement, and proceeding to the channel assigned in the channel assignment message before transmitting any response.

17. The method of claim 11, further comprising receiving an acknowledgement from the PAN in response to the response to the channel assignment message.

18. The method of claim 11, further comprising transmitting to the RAN at least one additional copy of the response to the channel assignment message.

19. A radio access network (RAN) comprising:
a transmitter;
a receiver; and
a controller, coupled to the transmitter and receiver, adapted to receive a request from a calling unit for a communication service involving a remote unit, adapted to instruct the transmitter to transmit to the remote unit via a paging channel a channel assignment message that assigns the remote unit to a traffic channel, adapted to receive from the remote unit via the receiver a response to the channel assignment message, wherein the response indicates an availability of the remote unit and a remote unit RAN location, adapted to indicate to the calling unit that the remote unit is available, and adapted to proceed with further call setup messaging with the remote unit via the transmitter and receiver.

20. A remote unit comprising:
a receiver;
a transmitter; and
a processor, coupled to the transmitter and receiver, adapted to receive via the receiver, from a radio access network (RAN) via a paging channel, a channel assignment message that assigns the remote unit to a traffic channel, adapted to instruct the transmitter to transmit to the RAN a response to the channel assignment message, wherein the response indicates an availability of the remote unit and a remote unit RAN location, and adapted to proceed with further call setup messaging on the traffic channel with the RAN.
